(19) United States
(12) Patent Application Publication
(10) Pub. No.: US 2014/0047940 A1
(43) Pub. Date: Feb. 20, 2014

(54) MULTI-JOINT ROBOT WITH BOTH-SIDE SUPPORTED ARM MEMBER

(71) Applicant: FANUC Corporation, Minamitsuru-gun (JP)

(72) Inventor: Masahiro YAMAMOTO, Minamitsuru-gun (JP)

(73) Assignee: FANUC Corporation, Minamitsuru-gun (JP)

(21) Appl. No.: 13/966,530

(22) Filed: Aug. 14, 2013

Related U.S. Application Data
(60) Provisional application No. 61/692,300, filed on Aug. 23, 2012.

(30) Foreign Application Priority Data
Aug. 20, 2012 (JP) 2012-181502

(51) Int. Cl. B25J 17/00

(52) U.S. Cl. CPC B25J 17/00
USPC 74/490.05

(57) ABSTRACT

In a multi-joint robot (1) including a first arm member (A1) providing a U-shaped portion (10) composed of two protrusion units (11, 12) parallel with each other, and including a second arm member (A2) connected to two protrusion units of the U-shaped portion so as to be rotated and such that both sides of the second arm member are supported by two protrusion units, the first arm member is formed by two half form portions (31, 32) that are divided between the two protrusion units of the U-shaped portion and are divided on a plane perpendicular to a rotational axis of the second arm member. Moreover, the first arm member includes a coupling unit (45a, 45b) for coupling two half form portions to each other.

### BACKGROUND OF THE INVENTION

1. Field of the Invention

The present invention relates to a multi-joint robot that includes a both-side supported arm member.

2. Description of the Related Art

A multi-joint robot including a plurality of joints is widely used. A general multi-joint robot includes a first arm member including a U-shaped portion, and a second arm member connected to the U-shaped portion so as to be rotated. Such an arm member that is referred to as a both-side supported arm member is disclosed in Japanese Unexamined Patent Publication No. H07-124886, Japanese Examined Patent Publication No. H06-30852, and Japanese Unexamined Patent Publication No. 2011-5635.

Incidentally, the first arm member and the second arm member of the multi-joint robot are manufactured by casting, for example, sand casting, gravity casting, or die casting. Among these types of casting, die casting is superior in size precision and stability, and is widely used since low-cost mass production is possible.

FIG. 14A and FIG. 14B are sectional views of dies used in the die casting. As illustrated in FIG. 14A, when a cast metal C0 is formed between the two dies B1 and B2, the dies B1 and B2 are moved in the respective die opening directions and opened, and the cast metal C0 is taken out. On the contrary, in FIG. 14B, undercut portions C1 and C2 are provided in the cast metal C0. For this reason, the undercut portions C1 and C2 become obstacles, so that the one die B2 is not to be opened in the die opening direction, and accordingly, the cast metal C0 is not to be taken out.

FIG. 15 is a sectional view of dies for forming the first arm member of the multi-joint robot. When the first arm member A1 including the U-shaped portion is formed, a die opening direction of the dies illustrated in FIG. 15 is the same as the direction of the rotational axis in a certain case. However, in this case, the U-shaped portions of the first arm member A1 correspond to the undercut portions. For this reason, the dies B1 and B2 are not opened, so that the first arm member A1 is not to be taken out.

Moreover, the robot houses in a hollow portion inside the arm member, power transmitting elements, for example, a gear and a belt, and a umbilical member, for example, a wiring and a tube. The reason for this is to prevent the power transmitting elements and the umbilical member from being exposed to the outside. However, in a certain case, depending on a shape of the hollow portion, the hollow portion may correspond to the undercut portion, so that the arm member is not to be taken out from the die.

For these reasons, in particular, when the arm member of the robot is formed, the sand casting is often adopted instead of the die casting. However, in the sand casting, after casting, the sand die is broken to scrape out the sand. For this reason, in the sand casting, a troublesome work is performed, which leads to an increase in manufacturing cost.

With the view of the above-described problem, the present invention was made. An object of the present invention is to provide a multi-joint robot that can be manufactured by die casting even when a both-side supported arm member is formed.

### SUMMARY OF THE INVENTION

In order to accomplish the above-described object, according to a first aspect, there is provided a multi-joint robot that includes a first arm member providing a U-shaped portion formed by two protrusion units parallel with each other, and that includes a second arm member connected to the two protrusion units of the U-shaped portion so as to be rotated and such that both sides of the second arm member are supported by the two protrusion units, wherein the first arm member is formed by two half form portions that are divided between the two protrusion units of the U-shaped portion and are divided on a dividing plane perpendicular to a rotational axis of the second arm member, and wherein the first arm member includes a coupling unit for coupling the two half form portions to each other.

According to a second aspect, in the first aspect, each of the half form portions is formed by two half form sub-portions that are divided by an additional plane parallel with the aforesaid dividing plane, and wherein each of the aforesaid half form portions includes an additional coupling unit for coupling the two half form sub-portions to each other.

These object, feature and advantage, and other objects, features and advantages of the present invention will become more apparent from the detailed description of the typical embodiments of the present invention that are illustrated in the attached drawings.

### BRIEF DESCRIPTION OF THE DRAWINGS

FIG. 1 is a perspective view of a multi-joint robot based on the present invention;

FIG. 2 is an elevation of a first arm member based on a first embodiment of the present invention;

FIG. 3 is a sectional view of dies for one of half form portions that constitutes the first arm member;

FIG. 4 is a perspective view of the two half form portions that constitutes the first arm member;

FIG. 5 is an elevation of the first arm member based on a second embodiment of the present invention;

FIG. 6 is a sectional view of dies for one half form sub-portion that constitutes the first arm member;

FIG. 7 is a sectional view of dies for another half form sub-portion that constitutes the first arm member;

FIG. 8 is a perspective view of four half form sub-portions that constitute the first arm member;

FIG. 9 is a perspective view of the first arm member;

FIG. 10 is a partial perspective view seen along the line A-A in FIG. 9;

FIG. 11 is a sectional view of the first arm member and a second arm member according to a certain embodiment;

FIG. 12 is a sectional view of the first arm member and the second arm member according to another embodiment;

FIG. 13 is a sectional view of the first arm member and the second arm member according to a still another embodiment;

FIG. 14A is a sectional view of dies used in die casting;

FIG. 14B is another sectional view of dies used in die casting; and

FIG. 15 is a sectional view of dies for forming a first arm member of a multi-joint robot.

### DETAILED DESCRIPTION

In the following, the embodiments of the present invention will be described with reference to the drawings. In the following drawings, the same reference symbols are given to the same members. To facilitate understanding, reduced scales in these drawings are appropriately changed.

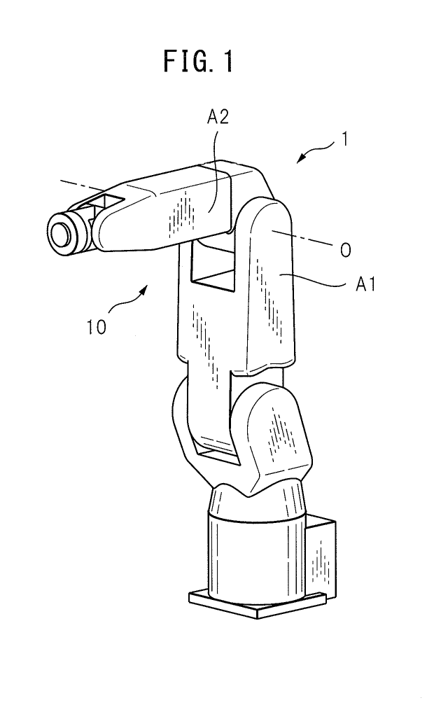

FIG. 1 is a perspective view of a multi-joint robot based on the present invention. As illustrated in FIG. 1, the multi-joint robot 1 includes a plurality of arm members. The first arm member A1 among such a plurality of arm members as these includes a U-shaped portion 10. The second arm member A2 is connected to the U-shaped portion 10 of the first arm member A1 so as to be rotated. Moreover, in FIG. 1, the rotational axis O of the second arm member A2 is illustrated.

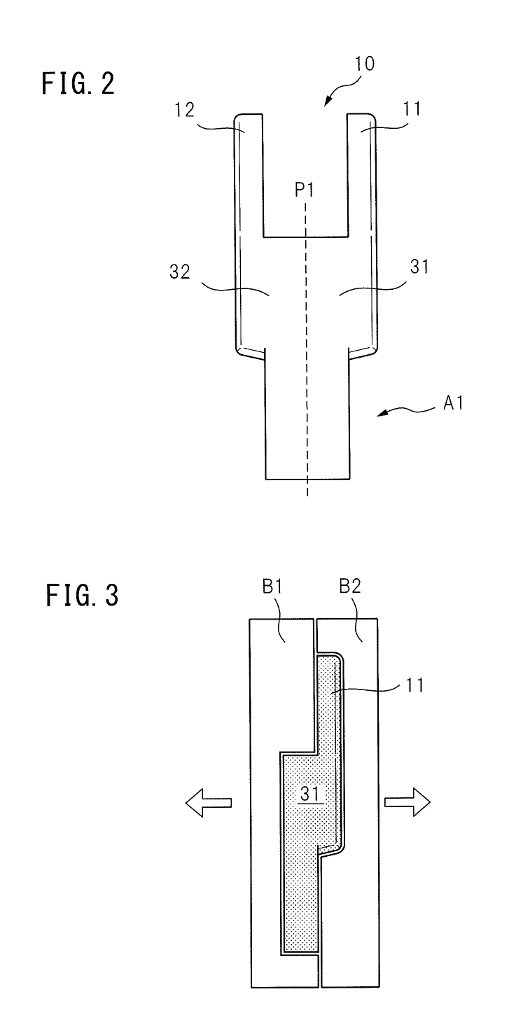

FIG. 2 is an elevation of the first arm member based on a first embodiment of the present invention. The U-shaped portion 10 of the first arm member A1 includes two protrusion units 11 and 12 parallel with each other. In FIG. 2, at a center between these protrusion units 11 and 12, a plane P1 is illustrated. This plane P1 extends in a direction approximately perpendicular to the rotational axis O (refer to FIG. 1) of the second arm member A2. Two portions formed by dividing the first arm member A1 with the plane P1 are called half form portions 31 and 32.

FIG. 3 is a sectional view of dies for one of the half form portions that constitutes the first arm member, and according to the first embodiment, the half form portions 31 and 32 are formed by die casting. In FIG. 3, the dies B1 and B2 for the one half form portion 31 are illustrated. The boundary plane between the dies B1 and B2 is at the position corresponding to an inner wall of the protrusion unit 11. When the dies B1 and B2 are thus arranged, an undercut portion is not produced in the half form portion 31. Accordingly, the dies B1 and B2 can be opened in the same direction as the direction of the rotational axis O so that the half form portion 31 can be taken out. The same description applies to the other half form portion 32.

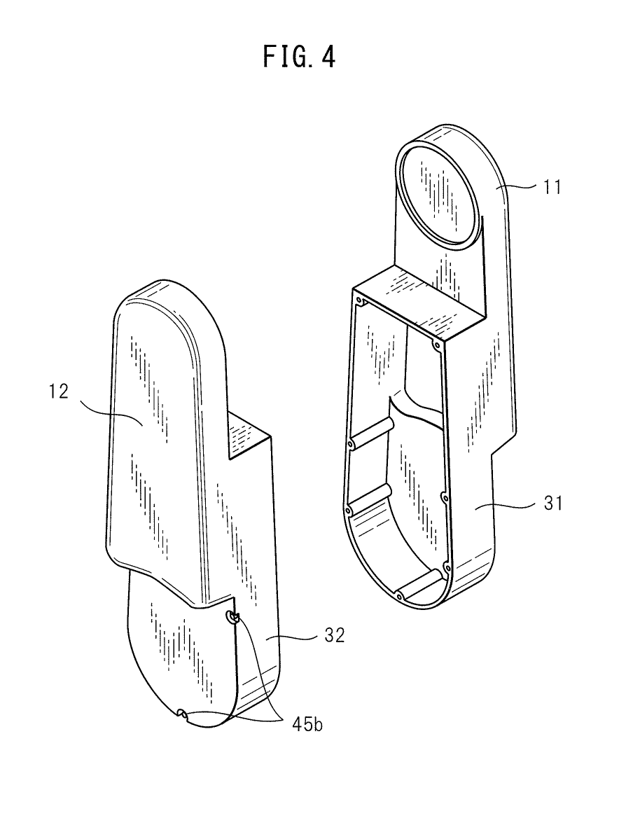

Thereby, as illustrated in FIG. 4, the two half form portions 31 and 32 are formed. As can be seen from FIG. 4, a concave portion for housing power transmitting elements and a umbilical member is formed in each of the half form portions 31 and 32 in the inside thereof. These half form portions 31 and 32 are assembled to form the first arm member A1, and, the above-described concave portions form the hollow portion inside the first arm member A1.

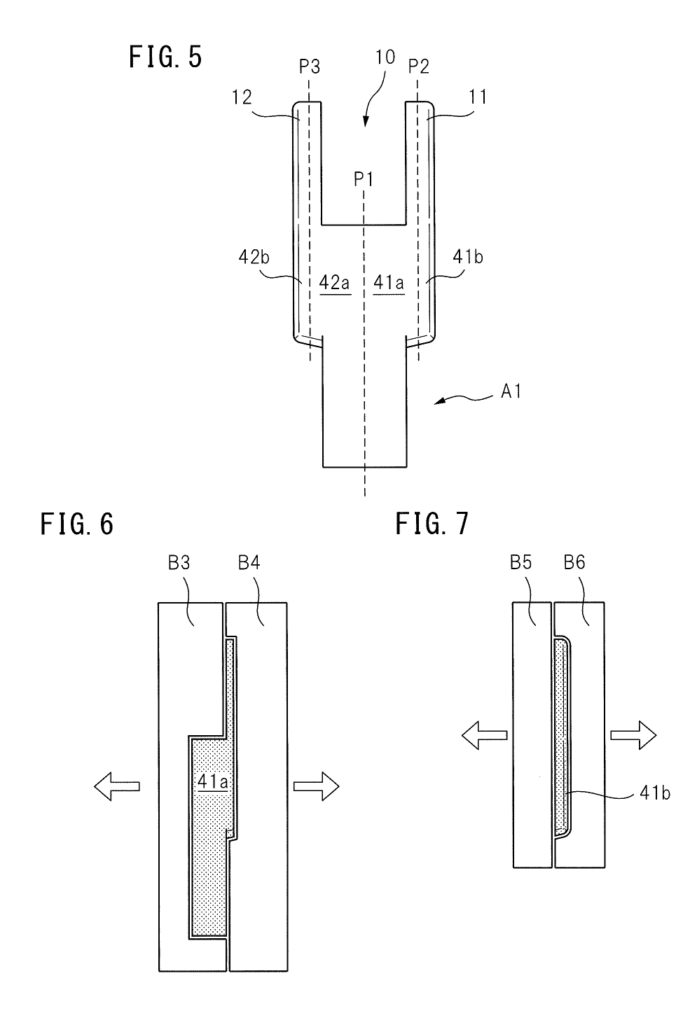

FIG. 5 is an elevation of the first arm member based on a second embodiment of the present invention. In FIG. 5, in addition to the above-described plane P1, the additional planes P2 and P3 that pass through approximately the middle positions of the protrusion units 11 and 12 are illustrated respectively. As can be seen from the drawing, these additional planes P2 and P3 are parallel with the plane P1. Four portions formed by dividing the first arm member A1 with the plane P1 and the additional planes P2 and P3 are called half form sub-portions 41a, 41b, 42a and 42b. Moreover, it would be understood that the two half form sub-portions 41a and 41b correspond to the half form portion 31, and the two half form sub-portions 42a and 42b correspond to the half form portion 32.

FIG. 6 is a sectional view of dies for the one half form sub-portion that constitutes the first arm member, and according to the second embodiment, the half form sub-portion 41a is formed by die casting. In FIG. 6, dies B3 and B4 for the one half form sub-portion 41a are illustrated. The boundary plane between the dies B3 and B4 is at the position corresponding to an inner wall of the protrusion unit 11. When such dies B3 and B4 are thus arranged, an undercut portion is not produced in the half form sub-portion 41a. Accordingly, the dies B3 and B4 can be opened in the same direction as the direction of the rotational axis O so that the half form sub-portion 41a can be taken out. The same description as for the half form sub-portion 41a applies to the other half form sub-portion 42a.

FIG. 7 is a sectional view of dies for another half form sub-portion that constitutes the first arm member, and according to the second embodiment, the half form sub-portion 41b is formed by die casting. In FIG. 7, the dies B5 and B6 for the other half form sub-portion 41b are illustrated. The boundary plane between the dies B5 and B6 is at the position corresponding to an approximately center of the protrusion unit 11. When dies B5 and B6 are thus arranged, an undercut portion is not produced in the half form sub-portion 41b. Accordingly, the dies B5 and B6 can be opened in the same direction as the direction of the rotational axis O so that the half form sub-portion 41b can be taken out. The same description as for the half form sub-portion 41b applies to the other half form sub-portion 42b.

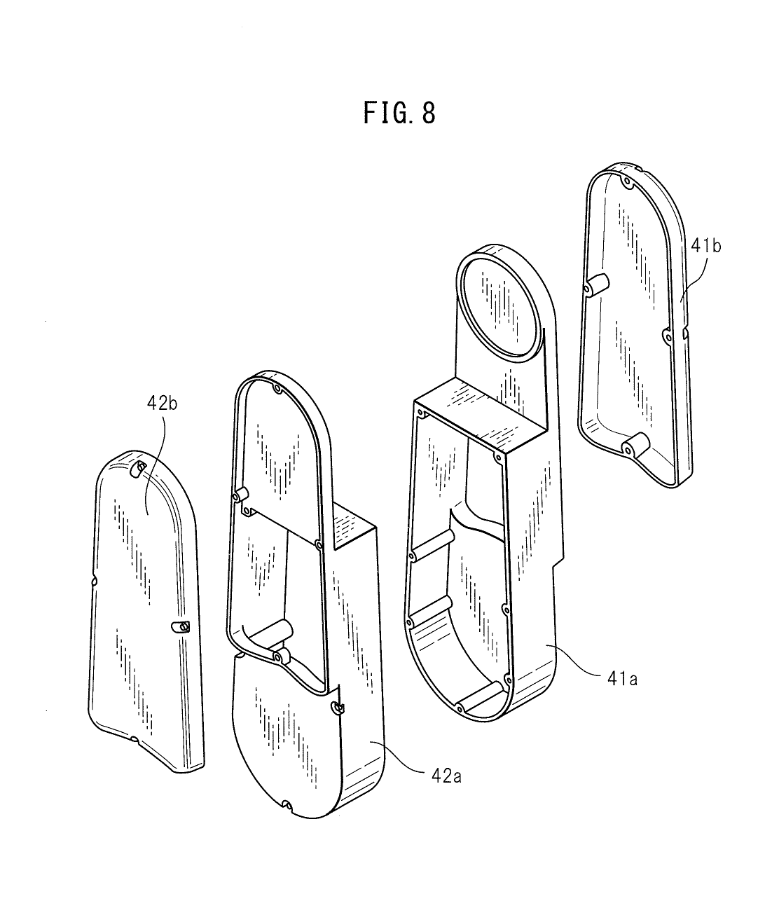

Thereby, as illustrated in FIG. 8, the four half form sub-portions 41a, 41b, 42a and 42b are formed. As can be seen from FIG. 8, a hollow portion or a concave portion for housing power transmitting elements and a umbilical member is formed in each of the half form sub-portions 41a, 41b, 42a and 42b in the inside thereof. These half form sub-portions 41a, 41b, 42a and 42b are assembled to form the first arm member A1, and the above-described concave portions form the hollow portion inside the first arm member A1.

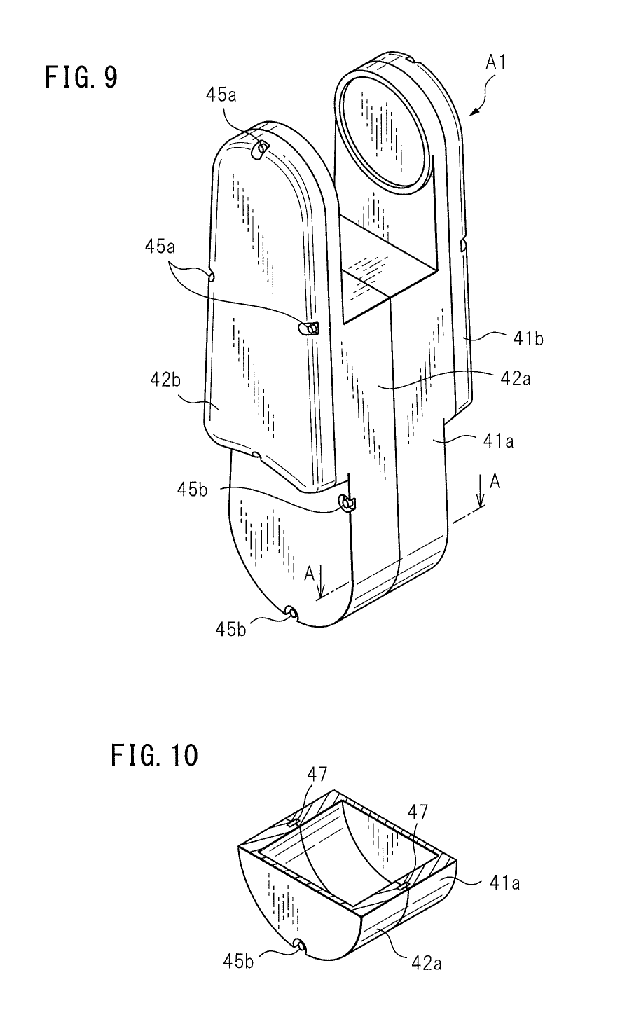

FIG. 9 is a perspective view of the first arm member. The first arm member illustrated in FIG. 9 is constituted by the half form sub-portions 41a, 41b, 42a and 42b. The half form sub-portion 42a and the half form sub-portion 42b are coupled to each other by short bolts 45a. This description applies to the half form sub-portion 41a and the half form sub-portion 41b. Further, the half form sub-portion 41a and the half form sub-portion 42a are coupled to each other by long bolts 45b. These short bolts 45a and the long bolts 45b function as a coupling unit.

In addition, in the same manner, the half form portions 31 and 32 are assembled to form the first arm member A1. In this case, however, note that the long bolts are used (refer to FIG. 4).

FIG. 10 is a partial perspective view seen along the line A-A in FIG. 9. As illustrated in FIG. 10, at a coupling portion between the half form sub-portion 41a and the half form sub-portion 42a, aligning pins 47 are provided. These aligning pins 47 can improve aligning precision. Further, seal members such as O-rings and packing not illustrated in the drawings may be arranged on respective coupling surfaces between the half form sub-portions 41a, 41b, 42a and 42b. Alternatively, sealing agents not illustrated in the drawings may be applied to the coupling surfaces. Thereby, a waterproofing function can be given to the first arm member A1 of the robot.

Thus, according to the present invention, the first arm member A1 of the both-side supported type can be formed by die casting. In other words, according to the present invention, as it is not necessary to perform the sand casting, the multi-joint robot 1 including the high-quality arm member A1 can be mass-produced at low cost while manufacturing cost can be suppressed.

Thus, according to the first embodiment, the first arm member A1 including the U-shaped portion is divided by the above-mentioned plane P1 to form the half form portions 31 and 32. By arranging the dies such that an undercut portion are not included, these half form portions 31 and 32 can be formed by die casting to produce the first arm member A1.

Further, according to the second embodiment, the one half form portion 31 is constituted by the two half form sub-portions 41a and 41b, for example. Accordingly, it would be understood that the first arm member A1 having a more complicated shape can be produced with ease and at low cost.

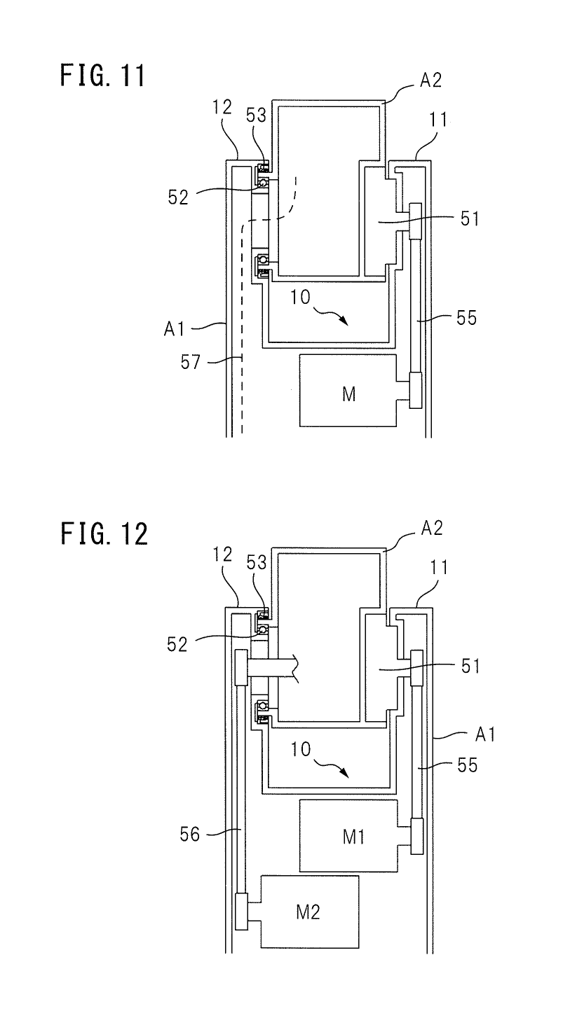

FIG. 11 is a sectional view of the first arm member and the second arm member according to a certain embodiment. As illustrated in FIG. 11, at one protrusion unit 11 of the first arm member A1, a speed reducer 51 is arranged. At the other protrusion unit 12, a bearing 52 is arranged. With this configuration, the second arm member A2 is sandwiched between the protrusion units 11 and 12 such that the second arm member A2 can be supported at the protrusion unit 11 by the speed reducer 51 and the bearing 52 so as to be rotated. Adopting such a both-side supporting configuration can make rigidity at a joint axis higher than that in a cantilever configuration. For this reason, a positional precision at the tip of the multi-joint robot 1 can be improved.

In case of the multi-joint robot 1 possessing a waterproofing function, as illustrated in FIG. 11, an oil seal 53 may be arranged around the bearing 52, or a waterproofing function may be given to the bearing 52. Thereby, it is possible to prevent water from entering the inside of the multi-joint robot 1 through the joint axis.

Moreover, in FIG. 11, below the U-shaped portion 10, a motor M is arranged. An output shaft of the motor M is connected to the speed reducer 51 by the power transmitting elements such as gears and a belt 55 that are arranged inside the protrusion unit 11. By the way, generally, the fine adjustment of the positions of the gears and the belt 55 is necessary to improve the positional precision of the multi-joint robot 1. When the first arm member A1 is constituted by four half form sub-portions 41a, 41b, 42a and 42b as described above referring to FIG. 8 and the like, only the outside half form sub-portion 41b, for example, is detached, then the gears and the belt 55 can be easily accessed. For this reason, according to the present invention, it is possible to improve the efficiency of adjusting positions of the gears and the belt 55.

Furthermore, in FIG. 11, the umbilical member 57, for example, a cable for a motor (not illustrated) arranged on the tip side of the second arm member A2, or an air tube for driving a hand (not illustrated) positioned at the tip of the multi-joint robot 1 is illustrated. Such umbilical members 57 are arranged so as to pass the inside of the protrusion unit 12 of the first arm member A1 through the bearing 52 from the second arm member A2. Accordingly, it is possible to keep the umbilical members 57 from being exposed to the outside of the multi-joint robot 1. The work of arranging such umbilical members 57 can be performed by detaching the outside half form sub-portion 42b only, for example. For this reason, according to the present invention, it is possible to improve the efficiency in work of arranging the umbilical members 57.

Further, when the speed reducer 51 having a hollow configuration is adopted, the umbilical members 57 can be arranged on the side of the protrusion unit 11. In such a case, the umbilical members 57 and the above-described power transmitting elements, for example the gears and the belt 55, are arranged in the same protrusion unit 11. Accordingly, by detaching one outside half form sub-portion 41b only enables both of adjusting the positions of the gears and the belt 55, and arranging the umbilical members 57.

FIG. 12 is a sectional view of the first arm member and the second arm member according to another embodiment. In FIG. 12, two motors M1 and M2 are arranged below the U-shaped portion 10. An output shaft of motor M1 is connected to the speed reducer 51 by the power transmitting elements, for example, the gears and the belt 55 that are arranged inside the protrusion unit 11. The other output shaft of motor M2 is connected to a driven portion in the second arm member A2 by power transmitting elements, for example, gears and a belt 56 that are arranged inside the protrusion unit 12. Even in such a configuration, the adoption of the speed reducer 51 having a hollow configuration enables the power transmitting elements, for example, the gears and the belts 55 and 56, to be arranged inside the same protrusion unit 11. It would be apparent that even in such a case, the same advantage as described above can be obtained.

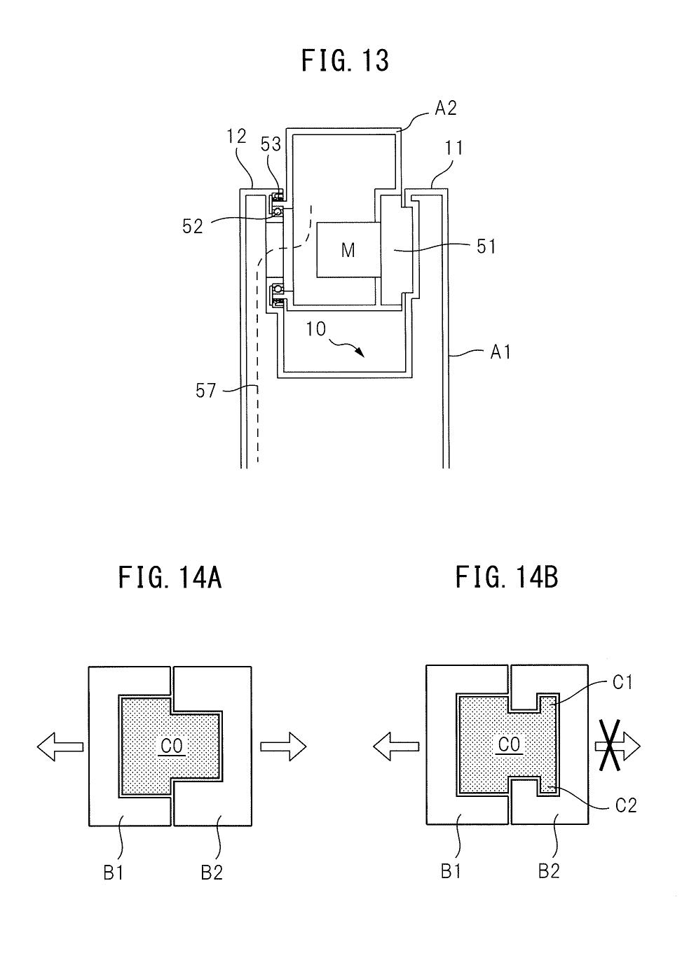

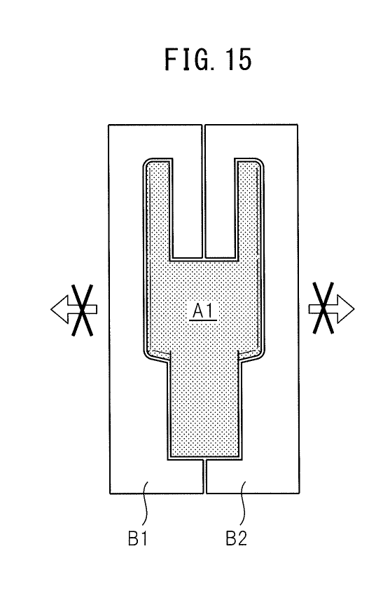

FIG. 13 is a sectional view of the first arm member and the second arm member according to a still another embodiment. In FIG. 13, the motor M is arranged inside the second arm member A2, and connected directly to the speed reducer 51. In such a case, the power transmitting elements, for example, the gears and the belt 55 can be excluded from a space inside the protrusion unit 11.

### ADVANTAGES OF THE INVENTION

According to a first aspect, the half form portions are formed by dividing the first arm member including the U-shaped portion by the above-described plane. By arranging the dies not to include the undercut portions, the half form portions are formed by the die casting to form the first arm member. In other words, according to the present invention, a sand casting does not need to be performed, so that the robot including the high-quality arm member can be mass-produced at low cost while manufacturing cost can be suppressed.

According to s second aspect, the half form portion is constituted by the two half form sub-portions, so that the first arm member having a more complicated shape can be produced with ease and at low cost.

The typical embodiments were used for describing the present invention, a person skilled in the art, however, would understand that the above-described alteration and various types of other alteration, omission and addition can be performed without departing from the scope of the present invention.

1. A multi-joint robot that comprising a first arm member providing a U-shaped portion formed by two protrusion units parallel with each other, and a second arm member connected to two protrusion units of the U-shaped portion so as to be rotated and such that both sides of the second arm member are supported by the two protrusion units,
wherein the first arm member is formed by two half form portions that are divided between the two protrusion units of the U-shaped portion and are divided on a dividing plane perpendicular to a rotational axis of the second arm member, and
wherein the first arm member includes a coupling unit for coupling the two half form portions to each other.

2. The multi-joint robot according to claim 1, wherein each of the half form portions is formed by two half form sub-portions that are divided by an additional plane parallel with the dividing plane, and
wherein each of the half form portions includes an additional coupling unit for coupling the two half form sub-portions to each other.
